(19) United States
(12) Patent Application Publication
(10) Pub. No.: US 2010/0011060 A1
(43) Pub. Date: Jan. 14, 2010

(54) METHODS AND APPARATUS FOR DISTRIBUTING CONTENT

(75) Inventors: Travis Hilterbrand, Gilbert, AZ (US); Frederic J. Buonincontri, Tempe, AZ (US)

Correspondence Address: Daniel J. Noblitt;The Noblitt Group, PLLC, 4800 North Scottsdale Road, Suite 6000, Scottsdale, AZ, 85251, US

(73) Assignee: Solid State Networks, Inc.

(21) Appl. No.: 12/499,784

(22) Filed: Jul. 8, 2009

Related U.S. Application Data
(60) Provisional application No. 61/079,061, filed on Jul. 8, 2008.

(51) Int. Cl. G06F 17/30; G06F 15/16

(52) U.S. Cl. 709/204; 707/3; 707/E17.014

(57) ABSTRACT

Methods and apparatus for transferring data according to various aspects of the present invention may operate in conjunction with a computer system configured to connect to a p2p network. The computer may run a p2p communication program that receives a list of content available for download and determines a list of missing content on the computer by comparing the list of content available for download to a list of content previously acquired. Each of the content available for download comprises only a current version of corresponding content available.

### CROSS-REFERENCES TO RELATED APPLICATIONS

This application claims the benefit of U.S. Provisional Patent Application No. 61/079,061. filed Jul. 8, 2008.

### BACKGROUND

Many software programs receive updates through patches, which may comprise one or more files or file segments. Software developers generally distribute patches in order to fix bugs or update the software. Patch files may be replacement files or may be new files that will expand software by creating new content, such as code, graphics, or data. Sometimes software developers make patches optional. However, in other instances, developers require users to download and install patches before they can initiate or resume use of the software.

By creating this requirement, numerous users may download the patch files simultaneously, thereby placing a massive burden on the network and servers. To provide this patch content to a large number of users, developers must have servers with sufficient bandwidth to serve those files. For many organizations, the expense of acquiring sufficient bandwidth to provide a satisfactory user experience is prohibitive.

In an effort to minimize the expense and difficulty associated with the distribution of a large amount of content through a network, various peer-to-peer (p2p) protocols and associated networks have been developed, such as BitTorrent, Gnutella, Skype, etc. A p2p network distributes content through the network using the computing power and bandwidth available to the network's individual users to transfer files instead of relying entirely on the bandwidth of a single server or group of servers.

The use of p2p networks provides a more efficient distribution of large amounts of content throughout the network. However, conventional patching systems typically use a series of sequential incremental patches, which can also be an inefficient and costly process. As a result, in such a system, a user may download a file in one patch that will be later overwritten by a newer version of that same file in a later patch. Thus, the conventional patching system may require a user to spend hours downloading numerous unnecessary patch files before being able to use the software.

### SUMMARY OF THE INVENTION

Methods and apparatus for transferring data according to various aspects of the present invention may operate in conjunction with a computer system configured to connect to a p2p network. The computer may run a p2p communication program that receives a list of content available for download and determines a list of missing content on the computer by comparing the list of content available for download to a list of content previously acquired. Each of the content available for download comprises only a current version of corresponding content available.

### BRIEF DESCRIPTION OF THE DRAWING FIGURES

Representative elements, operational features, applications and/or advantages of the present invention reside in the details of construction and operation as more depicted, described and claimed. Reference is made to the accompanying drawings, wherein like numerals typically refer to like parts.

FIG. 1 is a block diagram of a system for transferring data according to various aspects of the present invention;

FIG. 2 is a flow diagram for processing patch updates according to various aspects of the present invention; and

FIG. 3 is a comparison diagram for parallel downloading versus sequential downloading.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present invention.

Representative elements, operational features, applications and/or advantages of the present invention reside in the details of construction and operation as more fully hereafter described or otherwise identified. The description may refer to the accompanying drawings, images, figures, etc., wherein like numerals (if any) refer to like parts throughout. Elements, operational features, applications and/or advantages are illustrated by certain exemplary embodiments recited in the disclosure herein.

Elements in the figures, drawings, images, etc. are illustrated for simplicity and clarity and have not necessarily been drawn to scale. For example, the dimensions of some of the elements in the figures may be exaggerated relative to other elements to help improve understanding of various embodiments of the present invention. Furthermore, the terms ‘first’, ‘second’, and the like herein, if any, are used for distinguishing between similar elements and not necessarily for describing a sequential or chronological order. Moreover, the terms ‘front’, ‘back’, ‘top’, ‘bottom’, ‘over’, ‘under’, and the like in the disclosure and/or in the exemplary embodiments, if any, are generally employed for descriptive purposes and not necessarily for comprehensively describing exclusive relative position. Any of the preceding terms so used may be interchanged under appropriate circumstances such that various embodiments of the invention, for example, are capable of operation in other configurations and/or orientations than those explicitly illustrated or otherwise described.

### DETAILED DESCRIPTION OF EXEMPLARY EMBODIMENTS

The present descriptions relate to exemplary embodiments of the invention and the inventor's conception of the best mode and are not intended to limit the scope, applicability or configuration of the invention in any way. Instead, the following description is intended to provide convenient illustrations for implementing various embodiments of the invention. Changes may be made in the function and/or arrangement of any of the elements described in the disclosed exemplary embodiments without departing from the spirit and scope of the invention.

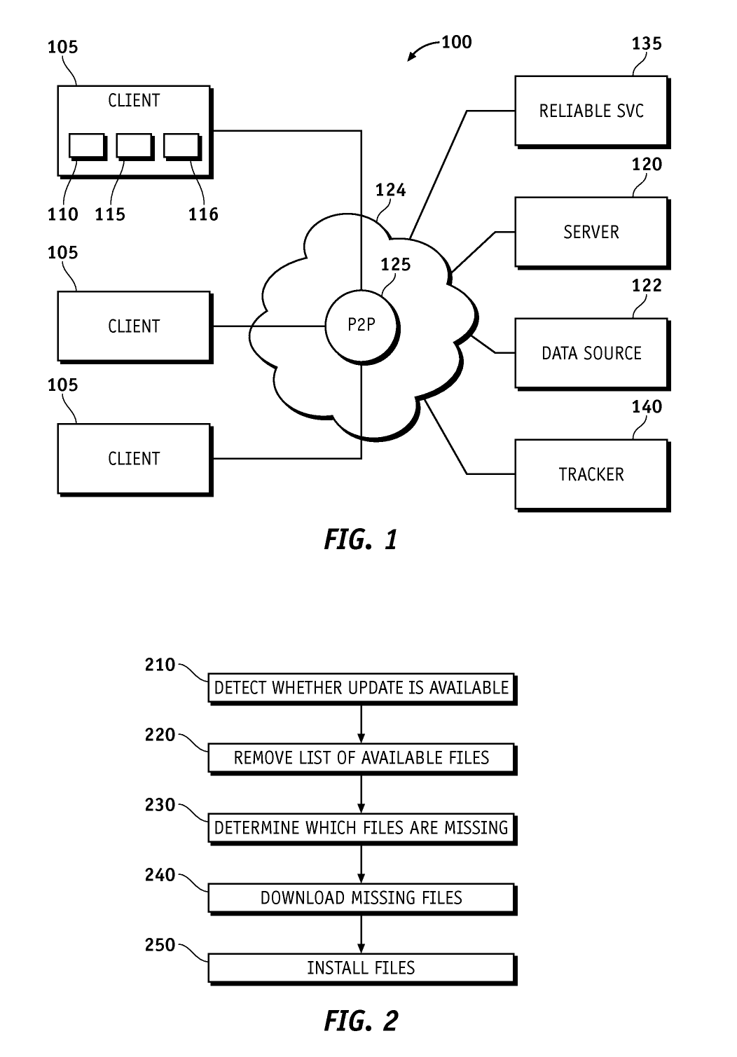

Referring to FIG. 1, a system for transferring data 100 according to various aspects of the present invention may function with multiple computers exchanging data. For example, the present exemplary system for transferring data 100 operates in conjunction with multiple clients 105 connected to each other and/or one or more remote servers 120 and/or other data sources 122 and/or trackers 140 via a medium 124. Data is transferred among the various clients 105, servers 120, trackers 140, and/or other data sources 122 via the communications medium 124.

The medium 124 facilitates the transfer of information, and may comprise any suitable medium for transferring information. For example, the medium 124 may comprise the Internet, a content delivery network, a local area network, or any other suitable wired or wireless communications network. In the present embodiment, the medium 124 may include a p2p network 125 comprising multiple devices configured to exchange information, such as using a BitTorrent protocol to distribute digital files. The p2p network 125 may, however, comprise a network of computers using alternative systems for communicating and distributing data or files via the medium 124, such as Microsoft's Avalanche system, Skype, Gnutella, Napster, or any other appropriate data or file distribution system.

Any appropriate systems and devices may be connected to the p2p network 125, such as clients 105, computers, entertainment systems, data sources 122, servers 120, and trackers 140. In the present embodiment, one or more data sources 122 may be connected to the p2p network 125 and provide data, for example in response to requests. The data sources 122 may comprise any suitable systems for providing data, such as a local storage media, networked storage systems and computers, web servers, databases, loopback network interfaces, cameras, PDAs, televisions, radios, and/or other recording or audiovisual systems, and the like.

In addition, the present embodiment may include one or more servers 120 that may operate as data sources 122 and provide other appropriate functions. The servers 120 may comprise any suitable computer systems or other electronic devices configured to communicate via the medium 124. For example, the servers 120 may comprise hardware, software, and/or networking components configured to receive and process requests from the clients 105 and provide a suitable website or other Internet-based user interface that is accessible by the clients 105. In one embodiment, the server 120 comprises a conventional networked computer server running an operating system, such as Microsoft Windows, Mac OSX, or Linux, and a web server, such as an Apache web server. The server 120 may comprise a daemon or software application, a physical computer that is connected to a network, and/or a combination of software and hardware.

In one embodiment, the system for transferring data 100 includes one or more reliable service servers 135. The reliable service server 135 may comprise a reliable resource for obtaining information via the p2p network 125 when such information is otherwise difficult to retrieve. For example, the reliable service server 135 may be configured to maintain a copy of a large portion, such as substantially all, of the content available via the p2p network or associated with one or more particular content providers. The reliable service server 135 may also comprise a highly reliable system that is consistently available to other network elements. Thus, in the event that a file or file segment cannot be readily retrieved from other network resources, the client 105 may access the reliable service server 135 to acquire the missing information. By doing so, the reliable service server 135 may improve file availability in the event of lower file segment availability from the other elements of the p2p network 125 and otherwise minimize the degradation of file transfer rate associated with the p2p network 125.

When the p2p network 125 performance is degraded such that it becomes difficult to retrieve particular file segments, the clients 105 may retrieve the file segments directly from the reliable service server 135 to mitigate the problems associated with the p2p network's 125 performance. Thus, if files are not available from other sources on the p2p network 125, such as due to the recent introduction of the file segments to the p2p network 125, the file segments may be retrieved from the reliable service server 135. Also, the reliable service server 135 may be used to mitigate performance degradation associated with downloading file segments from the p2p network 125, for example by providing particular file segments selected by the user or required by a patch update that are not immediately available from other sources in the p2p network 125.

The present embodiment may include one or more trackers 140 that may operate as a server 120, a data source 122, or any other appropriate function. The trackers 140 may receive, store, and/or transmit information via the medium 124. The trackers 140 may comprise any systems connected to a network for communicating and/or accessing data. For example, one or more trackers 140 may comprise conventional computers having a processor and a memory responsive to the processor, such as RAM, hard drives, CD-ROM drives and disks, HD-DVD/Blu-ray drives and disks, or other appropriate volatile or non-volatile memory systems. The trackers 140 may organize or control the routing of data between clients 105, servers 120, data sources 122, reliable source servers 135, or any other combination of the above. The tracker 140 may also enforce rules pertaining to the distribution of content and may provide reporting and analytics features relating to network load, capacity, topography, http sources, and other delivery statistics. Further, in one embodiment, the tracker 140 may determine a list of content. The list of content may correspond to the content available for download. The tracker 140 may determine the list of content available for download by comparing versions of various content. The tracker 140 may also communicate with various peers to coordinate distribution of content. Still further, the tracker 140 may also analyze or compare various content to determine the most current version.

The clients 105 may receive, store, and/or transmit information via the medium 124. The clients 105 may comprise any systems connected to a network for communicating and/or accessing data. For example, one or more clients 105 may comprise conventional computers having a processor and a memory responsive to the processor, such as RAM, hard drives, CD-ROM drives and disks, HD-DVD/Blu-ray drives and disks, or other appropriate volatile or non-volatile memory systems. Alternatively, the client 105 may comprise a television, stereo, radio, gaming console, telephone, personal media player, digital assistant, or other network-connected device that receives digital or analog media content.

In the present embodiment, the clients 105 execute software for requesting and providing information via the medium 124. For example, each client 105 may comprise a conventional computer system that runs an operating system, such as Microsoft Windows, Mac OSX, Windows CE, Windows XP Embedded, Linux or other PC or embedded operating system, and is capable of executing software and connecting to a network. The client 105 may connect to the network in many different ways, including a network cable connection or a wireless connection. Also, the client 105 may communicate through the network using any appropriate communication protocols, such as TCP/IP, UDP, etc. The client 105 may act as a peer, which assists in downloading files, whether it is through receiving/downloading files (leeching) or sending/uploading files (seeding), or both. Additionally, a client 105 may be a seed, which is a peer that has a complete copy of a file or batch of files. A client 105 may also be the original source peer, making it a solid seed.

One or more of the clients 105 may operate client applications 110 to receive and/or transmit data via the medium 124. The client application 110 may comprise any software capable of requesting and/or receiving data via the medium 124. The client application 110 may also request any appropriate data, such as digital data encoded in a particular format, such as a QuickTime video file, MP3 file, PostScript file, or Microsoft Windows executable file, that may be used by the client application 110 or another application to perform tasks. For example, the client application 110 may display information on a computer screen, play sounds through a soundcard, play or patch a game, transmit data to another device such as a computer or television, download and/or otherwise prepare data for use by another application, or otherwise use downloaded data.

The client application 110 may comprise, for example, solely patching software, or it may comprise any program that may require updates, such as a game, a media player, a downloading program, a file-sharing program, an operating system, or any other suitable program. In the present embodiment, the client application 110 includes a BitTorrent client that utilizes the BitTorrent protocol or any other suitable p2p protocol for data transfer. In the present embodiment, the client application 110 may also comprise software for patching or updating various software programs. The client application 110 may be custom and may operate independently of any other software. Alternatively, the client application 110 may be integrated into an existing patching system or any other applicable software. In either configuration, the client application 110 may have custom skin designs with branding, logos, advertising, marketing, or any other designs or communications that may be visible during the download process. Alternatively, the client application 110 may run silently in the background or only function through another program.

The client application 110 may include a communication program to cause the client 105 to receive the patch data, format or translate the patch data for use by the client application 110, assemble the data into a proper sequence, and/or provide the formatted and/or assembled data to another program or portion of the communication program for use. The client application 110 may comprise or operate in conjunction with a web browser, such as one or more plug-in programs that interact with the web browser. The plug-in may operate as separate code from the main program, for example to read or edit specific types of files, such as to play and watch Flash presentations in the web browser.

The client application 110 may be further configured to control responding to requests for files according to selected criteria. For example, the client application 110 may receive requests for files or file segments from other peers in the p2p network 125, determine the availability of the requested data, and respond according to the availability of the requested data and any other selected restrictions or rules. For example, the client application 110 may be configured to permit transfers to a requesting peer, unless the requesting peer is restricted, such as according to a listing of restricted peers or associated characteristics, such as domain names or other identifiers. Restrictions may be associated with particular domain names, clients, or other characteristics of the requesting peer. Restrictions may also be associated with other characteristics, such as characteristics of the file segments, activities of the client 105 receiving the request, activities of the content owner, requirements of the content owner, and/or other suitable criteria. The restrictions may comprise one or more rules, such as rules prohibiting responding to a download request from a restricted user, prohibiting responding during certain activity, prohibiting responding to a download request from a restricted domain, prohibiting responding to a download request for content not associated with a particular domain, or non-domain related restrictions.

In one embodiment, if the requested content is not associated with a particular domain name, the request is denied. For example, requests for content associated with a particular content provider's domain name may be fulfilled, while requests for content from another content provider may be denied. In another example, if the incoming file request is for content associated with content currently being downloaded by the client application 110, such as content originating from the same domain, the client application 110 may proceed with transferring the content to the requesting peer. If the requested content does not originate from the same domain or is otherwise unrelated to the content currently being downloaded by the client application 110, then the client application 110 may deny the file transfer request to avoid degrading download performance.

The files may comprise any suitable collections of information collected under a particular name, such as conventional computer files. The files may include subfiles or any other appropriate structure. In addition, the information in the files may be any appropriate information, such as data for sound, video, program data, patch information, game data, or the like. In many cases, to distribute a file, the content providers or the clients 105 of the p2p network 125 split a file into a series of file segments, such as in accordance with conventional BitTorrent distribution. The size of the file segments may be determined by several factors, including the performance of the medium 124 through which the clients 105 of the p2p network 125 communicate, the size of the original file, or other factors. When a client 105 wishes to retrieve a particular file from the p2p network 125, that client 105 can communicate with other clients 105 of the p2p network 125 to discover the availability of particular file segments that comprise the file. The clients 105 may then retrieve those file segments and then can combine them to recreate the original file.

The client application 110 may be configured to retrieve a p2p file description from server 120 or other data source 122. The p2p file description describes the file and provides sufficient data such that the file may be retrieved from the p2p network 125 and/or the reliable server service 135 or other data source 122. For example, the client application 110 may retrieve a webpage from the server 120 or other data source 122 that contains an HTML tag, such as an <EMBED> tag, that instantiates a translation server 115 and a patch-using program 116 or other file-using program and contains sufficient data for the translation server 115 to retrieve the file from the p2p network 125. In one embodiment, the translation server 115 and/or the patch-using program 116 are implemented as browser plug-ins that interact with the main or host application.

The <EMBED> tag may include a p2p file description containing all the information that the translation server 115 requires to retrieve a file from server 120, p2p network 125, or other source 122. Furthermore, the <EMBED> tag may include information that instructs the patch-using program 116 or other file-using program how to retrieve and play or otherwise utilize the file as it is subsequently provided by the translation server 115. For example, for a BitTorrent network, the <EMBED> tag may describe the URL of tracker 140 that communicates with the clients 105 that are connected to the p2p network 125 and are distributing file segments, the name of the file, the size of the file segments, the size of the file, and other information that allows the translation server 115 or client application 110 to verify the integrity of the file segments retrieved from the p2p network 125.

The file-using program may comprise any suitable system or application for using the received information. In the present embodiment, the file-using program comprises the patch-using program 116, which may comprise a conventional program for updating files, data, or other information based on electronic files or file segments, such as a game, operating system, document editing program, media program, or any other software that may receive updates. The file-using program may be selected according to the type of content or other appropriate criteria, and may comprise any appropriate program or system for using the received data, such as an entertainment player, a game, or other program. In addition, the file-using program may be initiated by an appropriate event, such as via update software, an update plug-in, or other program that initiates in response to a request to download and install patch files.

The translation server 115 may receive the file segments from the various network resources and provides the assembled file segments to the file-using program. The translation server 115 may comprise a software application executed by the client 105 and/or a remote computer configured to communicate with the requesting client 105. In the present embodiment, the translation server 115 comprises a program running on the requesting client 105, and may be initiated in response to a download request. For example, like the file-using program, the translation server 115 may be implemented as a web browser plug-in or other program that initiates the translation server 115 in response to a request to download and install patch files.

The p2p network 125 is suitably configured to communicate with the translation server 115 such that the translation server 115 is capable of communicating with the clients 105 and retrieving file segments from the p2p network 125. In the present embodiment, the translation server 115 and the file-using program may be initiated in response to file information indicating that the file is in a format compatible with the file-using program and distributed via a protocol compatible with the translation server 115. For example, the EMBED tag may indicate that the associated file is distributed via BitTorrent protocols, causing the client application 110 to initiate the translation server 115 to retrieve the file segments. In addition, the EMBED tag may indicate that the file type is a patch file, which may cause the client application 110 or the translation server 115 to initiate the patch-using program 116.

The translation server 115 requests and receives the file segments according any appropriate protocols and techniques. For example, the translation server 115 may request file segments according to BitTorrent or other file distribution processes. In the present embodiment, the translation server 115 contacts tracker 140 identified in the EMBED tag, accesses a distributed hash table, or otherwise determines network resources for requesting the relevant file segments. The translation server 115 then requests the file segments from the various identified network resources.

The translation server 115 may request file segments from the p2p network 125 according to the sequence of the file segments in the original file. By retrieving the file segments sequentially, the patch-using program 116 can consume the file segments' contents in substantially the same order as that in which they are received. The translation server 115 may also or alternatively request the file segments according to scarcity or availability on the p2p network 125 to allow optimal time to retrieve rare file segments.

As the translation server 115 receives the file segments, the translation server 115 may assemble the file segments into a proper sequence for transmission to the file-using program for consumption. For example, the translation server 115 may assemble the file segments of a patch into the proper sequence for installing updates.

The files may be received in the proper sequence, and may not require assembly. If the file segments are not received in sequential order, for example due to a request sequence, varying retrieval times for different file segments and network resources, varying connection qualities to network resources, or failed communications or requests, the translation server 115 may assemble the file segments into the proper sequence before providing them to the file-using program.

As the file segments are received and assembled, some file segments may not be found. The translation server 115 may request missing file segments by searching other network resources for the missing segments. In the present embodiment, the translation server 115 requests the file segments from various network resources according to a request procedure. In the present embodiment, the request procedure is configured to reduce burdens on central resources such as the servers 120 and the reliable service server 135, but retain the ability to acquire missing file segments. For example, the translation server 115 may initially request file segments from other clients 105. If a file segment cannot be retrieved from the other clients 105, the translation server 105 may request the missing file segment from the servers 120, which may have a greater selection of file segments but slower response times. If the missing file segment remains unavailable, the translation server may request the file segment from the reliable service server 135.

The translation server 115 may also translate incoming file segments into a format that can be used by the patch-using program 116, client application 110, or other appropriate system. In the present embodiment, the translation server 115 receives the file in a first format and retransmits received file to the file-using program using an alternative transmission protocol. For example, the present translation server 115 may retrieve file segments from the p2p network 125 using the BitTorrent protocol or other suitable peer-to-peer file transfer protocol and retransmit those file segments using an HTTP protocol. The translation server 115 may retransmit the file using any other appropriate protocols, such as RTSP, FTP, DSS, or by simply providing access to a file stored on a local or network-accessible storage system.

For example, the translation server 115 may retrieve the requested information from the p2p network 125 as BitTorrent file segments and convert the data into a local HTTP stream. The patch-using program 116 may then receive the data from the local HTTP stream as it is made available by the translation server 115. Thus, the translation server 115 may operate as a local server, such that patch-using program 116 associates the translation server 115 as an original source of the HTTP data. The patch-using program 116 may receive updates from the local server in the same manner as a remote source, for example from http://localhost/patch_file.txt rather than http://www.website.com/patch_file.txt. Consequently, the translation server 115 is effectively transparent to the patch-using program 116, and the patch-using program 116 does not require a specific configuration to operate with the p2p network 125 or other network resources.

The translation server 115 may provide the data in any appropriate manner, such as according to the type and availability of the downloaded data. For example, if the downloaded data comprises a non-sequential collection of data, such as a software program that cannot be executed until all elements are downloaded, the translation server 115 may retain the data until the file has been fully received and assembled, or may retransmit the data substantially immediately for assembly and/or use by the patch-using program 116 when all of the file segments have been received. If the data comprises a sequential presentation, the translation server 115 may retransmit data in the appropriate sequence as the relevant file segments are received. If the data is available, the information contained within the downloaded file segments may be retransmitted by the translation server 115 in approximately real-time, such that data is retransmitted generally as it becomes available. Thus, the translation server may begin streaming the data to the file-using program before the entire file has been received. Alternatively, retransmission may be delayed as determined by the requirements of the client application 110, user preferences, or other pre-determined input. The translation server 115 may also perform any other appropriate tasks to make the data useable by the patch-using program 116, such as processing interactions with the patch-using program 116.

To retrieve data for usage by the client 105, the client application 110 requests a particular file. In response, the system for transferring data 100 transmits the segments of the file to the client 105. As the file segments are received, the client application 110 may prepare the files for usage. For example, the translation server 115 may receive the file segments and provide the file segments to the patch-using program 116 as a local server. In addition, the translation server 115 may sequence, translate, and/or format the file segments for use by the patch-using program 116.

More particularly, the system for transferring data 100 may transfer information in response to a notification received and/or detected by the client application 110. For example, referring to FIG. 2, client application 110 operating on the client 105 may detect that an update is available (210). In one embodiment, the client application 110 may receive a notification from translation server 115, server 120, reliable service server 135, p2p network 125, or other source 122 that an update is available. The notification may comprise a communication sent to the client application 110 or information describing a patch and how to retrieve the patch from a p2p network 125. Alternatively, the client application 110 may detect that an update is necessary by manually or automatically inquiring for updates by comparing a list of previously acquired files on the client 105 to a list of available files on a server. The comparison may be performed by the client application 110 directly on the client 105 or may be done externally, such as on a server. Alternatively, the client application 110 may also detect that an update is necessary by comparing a date field stored on client 105, which may correspond to the last time an update was downloaded, to a date field on a server, which may correspond to the last time a new update was published. Further, it should that any suitable filed to which an update may be indicated or associated may also be used, for example, a version number.

The list of files, previously acquired and/or available, may be stored in a metadata file (metafile), a delimited text file, a database, or any other suitable location. The metafile may contain all of the information that is needed to deliver or receive a single piece of content. The filesystem organization, distribution metadata, and hashes may all be stored in the metafile.

In the preferred embodiment, the content previously acquired on a client 105 is compared to content available on the delivery network, as published via a list, such as a metafile, and stored on server 120, data source 122, reliable source server 135, tracker 140, or other source of data. In the present embodiment, a metafile on a tracker 140 comprises a SHA-1 hash that is compared to a SHA-1 hash for each file on a client 105 in order to verify the integrity of the content. Additionally, the metafile may be used to compare versions of a file in a patch with versions of a file in another patch.

Further, the metafile or other data source may provide information as to which files are required to immediately run the software as opposed to which files may be optionally downloaded for later use. For example, a user may be able to download update files through the client application 110 while the patch-using program 116 is running. The files may be downloaded to the client 105 while the program 116 is in use and then installed at a later time. Additionally, some files may even be installed during use of the program 116. Finally, the client application 110 may allow the client 105 to upload files to other clients 105 while the program 116 is running.

If an update is detected during the comparison, the client application 110 may then receive a list of available files (220). The list of available files may be received from any suitable source, such as a translation server 115, a server 120, a reliable source server 135, a tracker 140 or any other source 122. The list of available files may be stored in a metadata file, a delimited text file, a database, or any other suitable location. The list of available files may be published manually or automatically when files are updated or at regular time intervals. The list of available files may contain any suitable data, such as name, description, publisher, author, created date, modified date, and any other data. In addition, the list of available files may indicate which files are required for mandatory updates, which files are suggested, which files are optional, which files are to be installed at a future date, or any other indication that may assist the client application 110 or the user in downloading updates. Accordingly, the client application 110 may also receive a list that is a subset of files, such as only those files that are necessary for mandatory updates, such as those that must be downloaded in order for the software to continue operating.

In addition, the list of available files or another metadata file may point the client application 110 to a source for downloading the file, such as in accordance with a BitTorrent protocol. The list of available files may provide the p2p file description, which identifies one or more trackers 140 to identify network resources, such as clients 105, servers 120, and/or reliable service servers 135, from which the file may be retrieved. The client application 110 may then request the file segments from the various identified network resources.

The client application 110 may retrieve any type of data from the server 120. In the present embodiment, the client 105 may receive file data, such as an HTML tag, containing a description of the information to be retrieved. The file data may contain a p2p file description, for example using an <EMBED> tag. The p2p file description may include file size, file name, file type, file encoding information, local storage location and any other information that may be used to retrieve the file from the p2p network 125.

The client application 110 may then determine which files the client 105 is missing (230) by comparing the list of available files to the list of previously acquired files. In the present embodiment, the list of previously acquired files is stored on the client 105. The list of previously acquired files may be stored in a metadata file, a delimited text file, a database, or any other suitable location. The list of previously acquired files may also be determined by a list of files in various directories on the client 105. Alternatively, the list of previously acquired files may be stored at any suitable source, such as a translation server 115, a server 120, a reliable source server 135, or any other source 122. The list of previously acquired files may be published manually or automatically when files are updated or at regular time intervals. The list of previously acquired files may contain any suitable data, such as name, description, publisher, author, created date, modified date, and any other data. In addition, the list of previously acquired files may indicate if any of the files need updating because of errors, corruption, or other bugs. The client application 110 may determine which files the client 105 needs just to keep the software operating. The client application 110 may alternatively determine which files are to be installed at a future date.

In response to the missing file data, the client 105 may acquire the missing files (240). It should be understood that any suitable downloading method may be used, including but not limited to, parallel, sequential, or any other method, conventional or otherwise. For example, the files may be downloaded by initiating the translation server 115 to request the file segments, translate the file segments into a format for the patch-using program 116, and/or supply the file segments to the file-using program for use. In the present embodiment, the client application 110 initiates the translation server 115 in response to the file data, such as an indication that the file may be retrieved via the p2p network using BitTorrent protocols. Alternatively, the translation server 115 may already be running, for example in conjunction with a translation server 115 that is continuously running, started by a user, or otherwise initiated. The translation server 115 may be initiated by any appropriate system, such as the client application 110 or the patch-using program 116. The client 105 may also initiate the appropriate file-using program, such as the patch-using program 116, according to the type of data contained in the files to be received.

In response to the requests, the various network resources provide the file segments to the client application 110. For example, the client application 110 may notify the translation server 115 of the data request and provide to the translation server 115 the p2p file description that identifies the file to be retrieved and also contains sufficient information to retrieve the file from the p2p network 125. Upon receiving sufficient information from client application 100, the translation server 115 may communicate with the p2p network 125 and begin retrieving segments of the specified file, for example in accordance with the information in the <EMBED> tag. The translation server 115 suitably locates file segments made available by the various clients 105 of the p2p network 125, performs peer negotiation to acquire the file segments, and verifies the integrity of received files.

The file segments may be retrieved according to any appropriate criteria, such as the type of file being retrieved, p2p network 125 performance, and/or requirements of the client application 110 or patch-using program 116. For example, when downloading files that will not be installed until a later date or other data that will not be accessed immediately as it is received, such as game data or still-image data, the translation server 115 may seek file segments according to scarcity to download those file segments that are the least available in the p2p network 125 before other file segments that are more widely available. On the other hand, when the client application 110 requests streaming data, such as video, music, or other suitable files for immediate sequential presentation or execution, the user or application may wish to begin accessing the file as soon as possible. In such circumstances, when requesting data from the p2p network 125, the translation server 115 may employ a file segment selection algorithm that selects substantially sequential file segments to initially retrieve file segments from the beginning of the file before those nearer the end of the file. The translation server 115 may place priority on acquiring file segments that are to be used earlier on in the stream.

If the requested file segments are not readily available from the p2p network 125, the translation server 115, client application 110, and/or patch-using program 116 may request missing file segments from one of the reliable service servers 135. For example, if the clients 105 in the p2p network 125 do not have the relevant file segments, or if sufficient bandwidth is unavailable for a client 105 or other network resource having the file segment to transfer the file segments within a desired timeframe, the translation server 115 may stall the download process to find the file segment on another client 105 or one or more reliable service servers 135. If the file segments are found, the file segments are requested. If not, the translation server 115 may generate an error message indicating that the file or file segment was not found.

As the requested file segments are received, the translation server 115 may make the data contained within those file segments available to the client application 110 and/or the patch-using program 116. For example, the translation server 115 may retrieve all file segments associated with a particular file. After retrieving all file segments, the translation server 115 may assemble file segments so as to reconstruct the original file and then make that file available to the file-using program, such as the client application 110 or patch-using program 116. For example, if the original file is a graphics file, the translation server 115 may recombine the file segments so as to form the original graphics file and then may make the file available to the patch-using program 116.

The translation server 115 may make the file available to the patch-using program 116 using any suitable method. For example, the translation server 115 may provide an HTTP stream of the contents of the file. Alternatively, the translation server 115 may communicate the contents of the movie file to the patch-using program 116 using RTSP, FTP, DSS, or by simply providing access to a file stored on a local or network-accessible storage system.

The patch-using program 116 receives the data for use, such as playback, gameplay, or storage. In the present embodiment, as the translation server 115 receives the requested file segments, the translation server 115 provides an HTTP stream of the available file contents that the client application 110, patch-using program 116, and/or other file-using program may access. If the translation server 115 is running on the client 105, the HTTP file stream may be available at a local location, such as http://localhost/patch_file.txt. Thus, the patch-using program 116 receives the data from the translation server 115, which operates as a local HTTP server providing streamed data.

The client application 110 may install patch files as required by the software receiving the patch files (250). The patch files may be installed as they are downloaded, or, alternatively, they may be installed at a later date as required by the metadata controlling the update, the software receiving the patch, the client 105, or the client application 110.

The client application 110 may be further configured to control how the p2p client 105 responds to requests for file data. For example, the client application 110 may receive requests from other clients 105 and determine whether and how to respond to the requests, such as to deny the request, grant the request, or grant the request with conditions. Any appropriate criteria may be applied to determine the treatment of the request, for example to avoid degrading performance of incoming data transfers or apparent loss of performance caused by an outbound file transfer of which the user may be unaware. The criteria may be applied to the client 105 by any authority, such as the content owner, the network administrator, and/or the user of the client application 110. In addition, the client application 110 may receive the criteria directly or from any other resource, such as a reliable service server 135, a tracker server 140, or another server 120. Further, the criteria may be sent along with a file segment, such as in the metadata, embedded in the file segment, or otherwise attached.

In one embodiment, the client application 110 may have access to a set of request response criteria to enhance the user's experience and ensure that the user's perceptions of the content source are not inadvertently diminished. For example, the request response criteria may permit responding to requests when the client application 110 is not requesting and receiving files, but may prohibit responding to requests when the client application is requesting or receiving files to ensure that responding to the requests does not interfere with receiving the requested data.

Alternatively, the request response criteria may permit only responding to requests associated with particular domains or data, such as a domain associated with the client application 110, data that is currently being requested or received by the client application 110, or data associated with a particular source, like a website or domain name, that is currently being accessed by the client application 110, a browser, or an associated application. The restrictions may be generated to ensure that the user's experience with a particular content source is not degraded due to interference caused by transferring unrelated content. The request response criteria may include any criteria or action, such as limiting responses to domain specific content, content associated with a particular web site or group of sites being accessed by the client 105, distribution system specific content like BitTorrent files, or genre specific content. A file may additionally be limited by any associated data, such as size, name, keyword, creator, owner, or distributor. In addition, the limitation may be specific to the file segment, such as by limiting to certain sizes of file segment, or by identifying certain file segments by a flag or other identifier. The limitations may include terminating or delaying responses to all requests outside of a designated category, or limiting all requests outside of a designated category or a group of other peers. Further, all requests or certain requests may be serviced with conditions. The conditions may include any limitation, such as limiting the transfer rate of the connection, limiting the duration of transfer allowed, delaying the transfer until the user's download is complete, and/or restricting by file segment size or type.

In one embodiment, when a request is received from another peer in the p2p network 125, the client application 110 compares the request to the request response criteria, which may be configured to ensure that the user's experience is not degraded due to interference caused by servicing requests for unrelated content. If the client application 110 is not currently requesting and/or receiving content, the client application 110 may respond to the request and provide the requested content.

If the client application 110 is currently receiving or requesting content, the client application 110 may respond in any appropriate manner according to the request response criteria. In one embodiment, the client application 110 denies the request altogether until the client application 110 completes receiving and requesting content. In another embodiment, the client application 110 may deny requests unless the requested content fits within a permitted category. For example, the request may be denied under any circumstance unless the requested content is associated with a particular source, such as a domain name currently being accessed by the client 105 and/or associated with the content being downloaded by the client 105.

In one embodiment, the client application 110 includes a browser-integrated p2p file-sharing application, such as operating as a browser plug-in associated with a particular website. The client application 110 may deny requests for any content unless the content is associated with a website that is currently open in the browser. The content may be designated as associated with a website in any appropriate manner, such as providing a domain name corresponding to the content source in the p2p file description, like the EMBED tag.

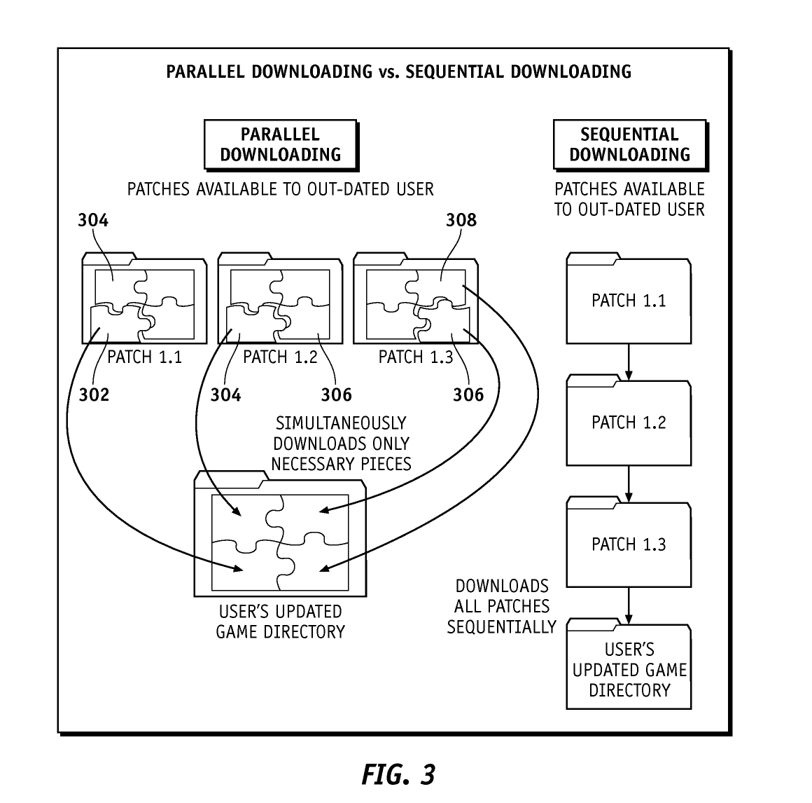

Referring to FIG. 3, a comparison chart 300 is shown that displays parallel downloading versus sequential downloading. Conventional patching systems use sequential downloading, which incrementally downloads patches in a linear fashion. For example, Patch 1.1 is downloaded first, then Patch 1.2 is downloaded, and finally Patch 1.3 is downloaded. All of these patches are entirely downloaded, even though some of the files in a later patch might be overwriting files in an earlier patch. A more efficient method for patching files is embodied in parallel downloading, which simultaneously downloads only the necessary pieces from each patch file. For example, in FIG. 3, Patch 1.1 comprises files 302, 304; Patch 1.2 comprises files 304, 306; and Patch 1.3 comprises files 306, 308. Since Patch 1.1 and Patch 1.2 comprise file 304, a sequential downloading system would download file 304 twice, in Patch 1.1 and again in Patch 1.2. However, in the parallel downloading system, file 304 would only be downloaded in Patch 1.2, assuming it has the most recent version of file 304. Similarly, file 306 is in Patch 1.2 and Patch 1.3. A sequential downloading system would download file 306 twice, while a parallel downloading system would only download file 306 from Patch 1.3. The sequential downloading system would have to download files 302, 304; then files 304, 306; and then files 306, 308. However, the parallel downloading system could simultaneously download files 302, 304, 306, and 308. Thus, instead of sequentially downloading six files, the parallel downloading system is able to simultaneously download four files.

In the foregoing specification, the invention has been described with reference to specific exemplary embodiments; however, various modifications and changes may be made without departing from the scope of the present invention as set forth in the exemplary embodiments. The specification and figures are to be regarded in an illustrative manner, rather than a restrictive one and all such modifications are intended to be included within the scope of the present invention. For example, the steps recited in any method or process embodiments may be executed in any appropriate order and are not limited to the specific order presented in the exemplary embodiments. Additionally, the components and/or elements recited in the apparatus embodiments may be assembled or otherwise operationally configured in a variety of permutations to produce substantially the same result as the present invention and are accordingly not limited to the specific configuration recited in the exemplary embodiments.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the exemplary embodiments.

As used herein, the terms “comprises”, “comprising”, “including”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A computer system configured to connect to a p2p network, comprising:
a processor configured to access the p2p network; and
a memory responsive to the processor, wherein the memory stores a p2p communication program configured to cause the processor to:
receive a list of content available for download, wherein each of the content available for download comprises only a current version of corresponding content available; and
determine a list of missing content on the computer system by comparing the list of content available for download to a list of content previously acquired.

2. A computer system according to claim 1, wherein the list of content available for download is determined by a tracker system.

3. A computer system according to claim 2, wherein the tracker system communicates with one or more peers connected to the p2p network to coordinate distribution of content to the computer system.

4. A computer system according to claim 2, wherein the tracker system compares corresponding versions of content to determine the current version.

5. A computer system according to claim 1, wherein each of the content available is not necessary to run a content-using program.

6. A computer system according to claim 1, wherein:
the content available for download comprises a BitTorrent file segment; and
the p2p communication program is configured to receive the BitTorrent file segment from a BitTorrent network.

7. A computer-implemented method for transferring content via a p2p communication program operating on a computer and a p2p network, comprising:
receiving a list of content available for download, wherein each of the content available for download comprises only a current version of corresponding content available; and
determining a list of missing content on the computer by comparing the list of content available for download to a list of content previously acquired.

8. A computer-implemented method according to claim 7, wherein the list of content available for download is determined by a tracker system.

9. A computer-implemented method according to claim 8, wherein the tracker system communicates with one or more peers connected to the p2p network to coordinate distribution of content to the computer system.

10. A computer-implemented method according to claim 8, wherein the tracker system compares corresponding versions of content to determine the current version.

11. A computer system according to claim 7, wherein each of the content available is not necessary to run a content-using program.

12. A computer-implemented method according to claim 7, wherein:
the content available for download comprises a BitTorrent file segment; and
the p2p communication program is configured to receive the BitTorrent file segment from a BitTorrent network.

13. A medium storing computer-executable instructions for a p2p communication program, wherein the instructions are configured to cause a computer connected to a p2p network to:
receive a list of content available for download, wherein each of the content available for download comprises only a current version of corresponding content available; and
determine a list of missing content on the computer by comparing the list content available for download to a list of content previously acquired.

14. A medium according to claim 13, wherein the list of content available for download is determined by a tracker system.

15. A medium according to claim 14, wherein the tracker system communicates with one or more peers connected to the p2p network to coordinate distribution of content to the computer system.

16. A medium according to claim 14, wherein the tracker system compares corresponding versions of content to determine the current version.

17. A computer system according to claim 13, wherein each of the content available is not necessary to run a content-using program.

18. A medium according to claim 13, wherein:
the content available for download comprises a BitTorrent file segment; and
the p2p communication program is configured to receive the BitTorrent file segment from a BitTorrent network.

19. A tracker system configured to connect to a p2p network, comprising:
a processor configured to access the p2p network; and
a memory responsive to the processor, wherein the memory stores a p2p communication program configured to cause the processor to determine a list of content available for download, wherein each of the content available for download is determined by comparing corresponding versions of content available to determine a current version.

20. A tracker system according to claim 19, wherein the p2p communication program is further configured to cause the processor to determine a list of missing content on a separate computer system by comparing the list of content available for download to a list of content previously acquired by the separate computer system.

21. A tracker system according to claim 19, wherein the tracker system communicates with one or more peers connected to the p2p network to distribute file segments to a separate computer system.
